(19) United States
(12) Patent Application Publication
(10) Pub. No.: US 2016/0041989 A1
(43) Pub. Date: Feb. 11, 2016

(54) INFORMATION SYSTEM AND METHOD FOR DEVELOPING AN INFORMATION SYSTEM

(71) Applicant: ROBERT BOSCH GMBH, Stuttgart (DE)

(72) Inventors: Klaus Schneider, Ludwigsburg (DE); Jochen Ansel, Bietigheim-Bissingen (DE)

(21) Appl. No.: 14/782,514

(22) PCT Filed: Feb. 28, 2014
(86) PCT No.: PCT/EP2014/053922

§ 371 Date: Oct. 5, 2015

(30) Foreign Application Priority Data
Apr. 12, 2013 (DE) 10 2013 206 559.0

(51) Int. Cl. G06F 17/30

(52) U.S. Cl. CPC G06F 17/3056; G06F 17/30339

(57) ABSTRACT

An information system, for a motor vehicle workshop, has a user input unit for a use to input at least one feature; a database contains data sets and at least one link table having fields for linking the data sets, each data set including at least one feature and at least one first allocation list having at least one allocation list element linking the data set with at least one field in the at least one link table; a selection unit to select from the database at least one data set having at least one of the features inputted as the first data set; and an allocation unit to evaluate the first allocation lists of the data sets and to select as second data sets those data sets whose first allocation list contains at least one allocation list element linking the respective data set with a field in the link table that is linked with the first data set by at least one allocation list element in the first allocation list of the first data set.

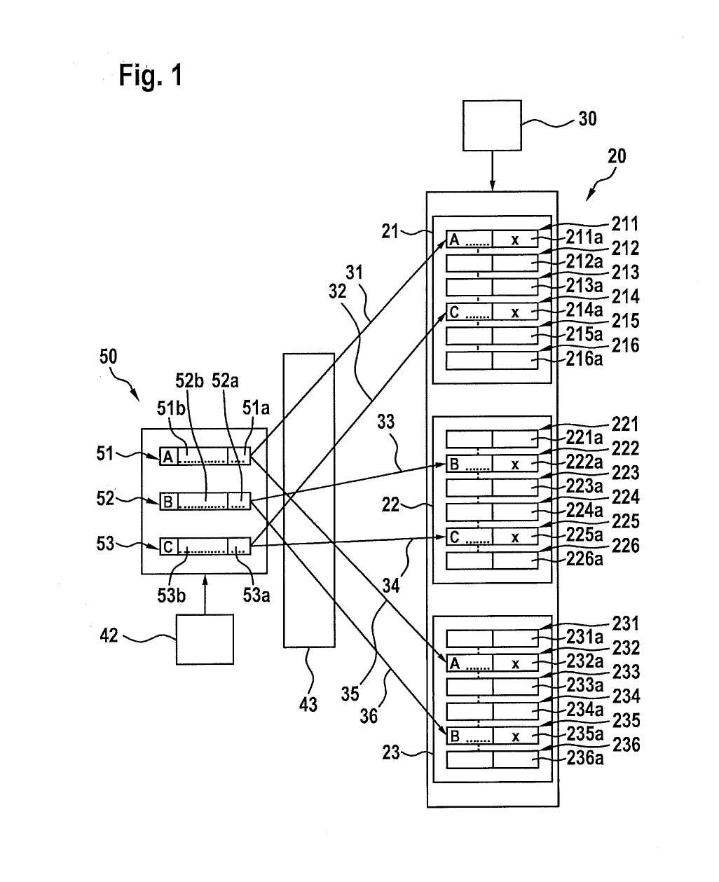

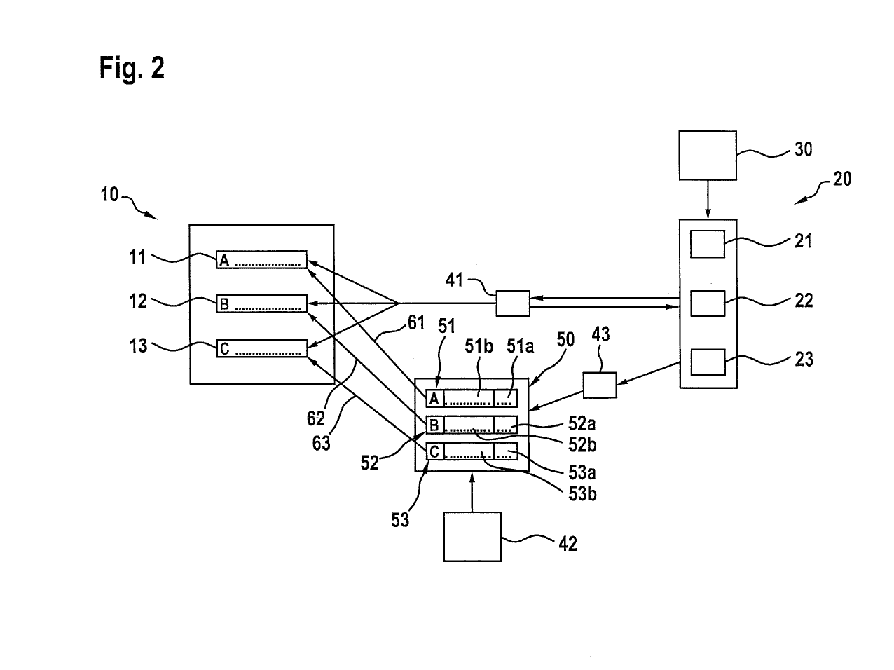

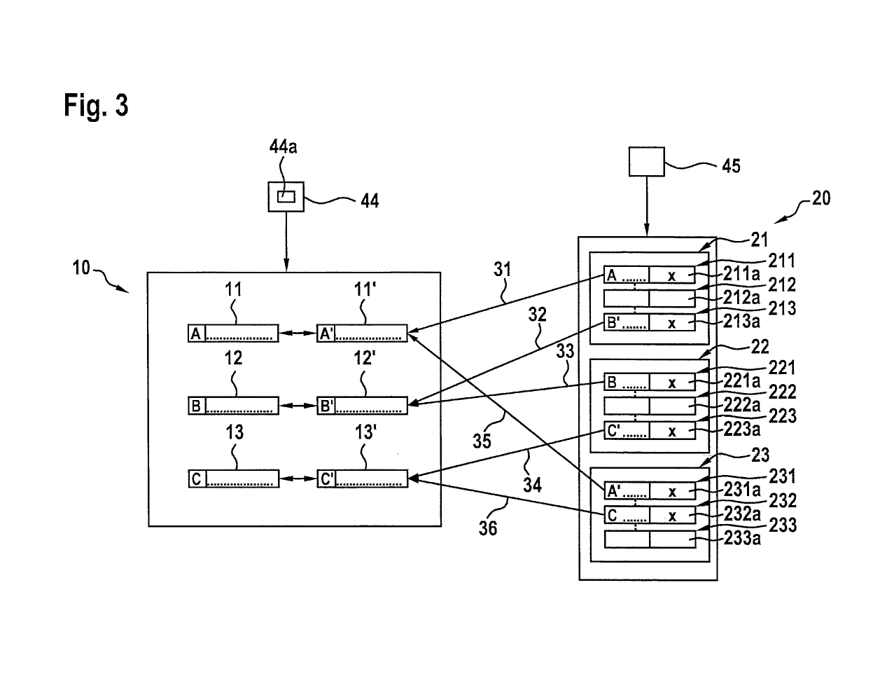

### FIELD OF THE INVENTION

The present invention relates to an information system and to a method for selecting and display information, in particular for supporting workers in motor vehicle workshops.

### BACKGROUND INFORMATION

In the existing art, workshop information systems are known that provide workers in the workshop with information on demand that is relevant for diagnosis and repair.

Patent document DE 195 23 483 A1 discusses a computer-supported error diagnosis unit for a complex system that is suitable in particular for motor vehicles, and that contains a knowledge base having a structure model, a function model, and a fault model.

Patent document DE 102 23 390 A1 discusses a human-machine interface (MMI) for a diagnostic system for diagnosing a technical system having a knowledge base and a diagnostic program that provides a first diagnostic result in the form of an initial data packet, having a data converter that, on the basis of a converter configuration, converts the initial data packet into an XML structure and stores it as an XML data file, a data completion unit that analyzes the data of the XML data file and, on the basis of the data of the initial data packet or after a manual request is made, reads further data (request) from the technical system to be diagnosed, and, after a conversion, using a completer configuration, adds the additional data as supplement to the XML data file, and having a visualization of the XML elements stored in the XML data file in the form of an interactive user interface.

### SUMMARY OF THE INVENTION

An object of the present invention is to optimize the selection and display of information stored in a database, and to provide an information system that is suitable for this purpose and is improved.

An information system according to the present invention provided in particular for use in a motor vehicle workshop has a user input unit via which at least one feature can be inputted by a user, and a database that contains a plurality of data sets and at least one link table having a plurality of fields for linking the data sets. Here, each data set includes at least one feature and at least one first allocation list having at least one allocation list element that links the data set with at least one field in the at least one link table. In addition, the information system has a selection unit that is fashioned to select at least one data set that contains at least one of the features inputted by the user as the first data set from the database, and an allocation unit that is fashioned to evaluate the first allocation lists of the data sets in the database and to select those data sets as second data sets whose first allocation list contains at least one allocation list element that links the respective data set with a field in the link table that is also linked with the first data set by at least one allocation list element in the first allocation list of the first data set. The selected second data sets can be displayed via a display unit in order to provide the user with the information contained in the data sets.

A method for selecting information, in particular in a motor vehicle workshop, includes the steps: inputting at least one feature using a user input unit; selecting at least one first data set that contains at least one of the features inputted by the user using a selection unit from a database that contains a plurality of data sets and at least one link table having a plurality of fields for link the data sets, each data set containing at least one feature and at least one first allocation list having at least one allocation list element that links the data set with at least one field in the at least one link table, and, based on the at least one selected first data set, selecting second data sets from the database, using a allocation unit, whose allocation list contains at least one allocation list element that links the respective data set with a field in the link table that is also linked with the first data set by at least one allocation list element in the first allocation list of the first data set. The content of the selected second data sets is displayed via a display unit, and is provided to the user.

A method according to the present invention and a device according to the present invention make it possible to provide a user automatically with, in addition to primarily requested information contained in a first data set, additional and potentially required secondary information linked to the first data set via the allocation lists and the link table. In this way, not only can a current request of the user be responded to, by providing the user with the (primary) information contained in the first data set, but the user can also be optimally supported with regard to future requests linked to the current request, by providing the user with additional (secondary) information that goes beyond the primarily requested information displayed via the display unit.

In particular, in addition to the primarily requested and displayed information, the user can also be provided with secondary information that is closely related to the primary information.

In a specific embodiment, at least one of the first allocation lists in the first data sets refers to two or more fields in the link table. In this way, a first data set can be linked to a plurality of second data sets by different linkages, so that complex data structures and links can also be mapped.

In a specific embodiment, the information system additionally has a filter unit that is fashioned to filter the selected second data sets, so that only information from a subset of the second data sets selected by the selection unit can be displayed by the display unit. The set of information displayed by the display unit can in this way be reduced in a targeted manner and limited to the most important information, so that the user can limit him or herself to the most important information, and will not be distracted and/or confused by an excess supply of less relevant information.

In addition, the data sets stored in the database can in each case contain at least one second allocation list, and the filter unit can be fashioned to evaluate the second allocation lists of the selected data sets in order to filter the data sets selected by the selection unit, so that only information from a subset of the selected data sets is displayed.

If the information system is used in a workshop, the second allocation lists can map individual workshop processes, in particular diagnostic processes, maintenance processes, and repair processes. In this way, it is possible to select those secondary items of information that, in the context of the respective workshop process, are closely related in terms of content and/or time to the primarily requested information.

For example, if the user is interested in a test procedure for checking a particular component, and it is known that, as the test proceeds, it is highly probable that it will be necessary or helpful to know the installation location and, possibly, the wiring/pin configuration, and the like, of the relevant components, an information system according to the present invention makes it possible to display for the user, in automated fashion, further relevant information that goes beyond the immediately required testing instructions, such as the installation location and/or the wiring/pin configuration of the component, without the user having to make an additional request for this purpose.

According to the present invention, the secondary information that can be predicted to be required in the course of the further carrying out of the particular workshop process can be identified automatically. The secondary information can then be immediately selected and displayed in order to make the user's work easier, and to avoid the necessity of a further request to the information system.

As a result, the additional information need no longer be sought explicitly by the user; rather, the user can quickly and easily access the information without having to make a new search in the information resources of the system, or to reparameterize a search engine. In this way, the user quickly recognizes which information in the system is available, because it is actively offered and does not have to be sought within hierarchical structures.

The relevance of the documents results from their content, i.e. purely technically, and no additional outlay is required in the creation of the documents. The relevance of newly created/added documents results automatically on the basis of its allocation lists; for this purpose, the already-present documents do not have to be updated either in their content or structurally.

In a specific embodiment, the data sets stored in the database are assigned priority values. In addition, a filter unit is provided that, when there is access to the selected data sets, compares their priority values to at least one specified threshold value and brings it about that on the display unit on the information is displayed from those data sets whose priority value is greater than a specified threshold value.

Through the priority values allocated to the data sets, in connection with at least one specified threshold value a measure can be created for the relevance or importance of the individual data sets, and by adjusting or varying the threshold value, it can be brought about that only the most important or most relevant information is outputted. In this way, the user is shown only the most important or most relevant information, and the user is not distracted and/or confused by the display of a large amount of less important or less relevant information.

In addition, the sequence in which the information is displayed can be ordered according to the magnitude of the priority values, and/or particularly relevant information can be highlighted or marked using color or in some other way.

In particular, safety-relevant information can be ranked as particularly important and can be given a high priority value. In addition, information can be ranked as particularly relevant if it fits particularly well in the current context and will therefore be required in the near future with a high probability.

In a motor vehicle workshop environment, the relevance of the information can in particular also be a function of the type of vehicle currently being worked on. Thus, in the database a plurality of priority values can be stored for each data set, the respectively used priority value being selected as a function of the current context, e.g. the vehicle type and/or the current workshop process.

In the case of use in a workshop, the database can in particular also contain information concerning various components of the motor vehicle, such as circuit diagrams, installation positions, disassembly and assembly descriptions, test sequences, and target values, allocated via the second allocation lists to various workshop processes and/or vehicle types.

In a specific embodiment, the selection unit makes it possible for a user to select one of the selected second data sets as the new first data set, and in this way to obtain additional information contained in new second data sets, which, as described above, are linked with the new first data set via the allocation lists and the linked table, and which usefully supplement the information contained in the selected new first data set.

Via an input unit, a user can input or modify parameters in the selection unit, the filter unit, and the selection unit.

In the following, the present invention is explained in more detail on the basis of the accompanying FIGURE.

The FIGURE shows a schematic representation of an information system according to the present invention.

### BRIEF DESCRIPTION OF THE DRAWINGS

The FIGURE shows a schematic representation of an information system according to the present invention having an input unit 2, a database 4, a display unit 8, and an allocation unit 6 functionally connected to input unit 2, display unit 8, and database 4.

Input unit 2, fashioned for example as a keyboard, mouse, voice input unit, or touch-sensitive screen (touchpad), or a combination thereof, receives a user request during operation and forwards it to selection unit 6.

In a first step, a first data set 20 that contains primary information relevant for the user request is selected from database 4. Information from first data set 20 can be displayed on display unit 8, which can be fashioned in particular as a screen, printer, and/or speech output.

First data set 20 also contains, in addition to the displayed information, a first allocation list 21 having one or more allocation list elements 21a, 21b, each allocation list element 21a, 21b linking first data set 20 with at least one field in a linked table 10 also stored in database 4. If the information system is used in a workshop environment, the fields of linked table 10 can for example represent the components of (motor) vehicles.

Selection unit 6 then selects, from all data sets 30, 40, 50 stored in database 4, those data sets as second data sets 30, 40 whose respective first allocation list 31, 41, 51 contains at least one allocation list element 21a, 21b, 31a, 31b, 31c, 41a, 41b, 51a, 51b that links the respective data set 30, 40, 50 with a field in linked table 10 that is also linked to first data set 20 by an allocation list element 21a, 21b in first allocation list 21.

In this way, in the exemplary embodiment shown in the Figure data sets 30 and 40 are selected as second data sets 30, 40.

Optionally, selection unit 6 can have connected downstream from it a filter unit 16 that acts as a programmable filter on second data sets 30, 40 selected by selection unit 6, and brings it about that only information is displayed on display unit 8 from those data sets 40 whose relevant priority value in the current context exceeds a specified threshold value.

By varying the threshold value used by filter unit 16, which can be inputted and modified for example via input unit 2, the scope of the information displayed on display unit 8 can be modified or adjusted in a targeted manner.

Alternatively or in addition, the filtering can also take place on the basis of second allocation lists 22, 32, 42, 52, also contained in data sets 20, 30, 40, 50.

In particular, a current context can be defined by the allocation list elements of second allocation lists 22, 32, 42, 52. If an information system according to the present invention is used in a workshop context, second allocation lists 22, 32, 42, 52 can for example create links on the basis of a current workshop process and/or on the basis of the type of the vehicle currently being worked on. Thus, for a diagnostic process, for a repair process, and for maintenance work, different allocation list elements can respectively be provided in second allocation lists 22, 32, 42, 52. In addition, for each vehicle type different allocation list elements can be provided in second allocation lists 22, 32, 42, 52, so that the current context results from a combination of the workshop process currently being carried out with the type of vehicle currently being worked on in the respective workshop process.

The user specifies the context by specifying identifying features of the vehicle, e.g. by inputting the brand, the model, the year of manufacture, and/or the vehicle identification number, and the currently relevant information type, e.g. the “installation position,” and the relevant component, e.g. “starter battery,” “injection pump,” “air conditioning compressor,” or “throttle valve.”

Therefore, the user of the information system is provided not only with the information primarily requested in the first step, but rather can in addition automatically be provided with further information that he will probably require in the current context or in the near future. The system here operates better the more specifically the current context is specified.

Optionally, information can also be displayed that is not valid for the selected vehicle or the current context, but that relates to similar vehicles, or to a related context. The measure of similarity can be determined mathematically for example by a weighting of the identification criteria and information types. Such an approach makes use of the fact that very detail-rich information cannot be generalized; in contrast, other information, such as the installation location of components in various models from the same manufacturer, is often the same or at least very similar.

With an information system according to the present invention, the display of the relevant information is simplified, because the user does not actively have to search for additional relevant information, or specify further search parameters. Rather, this task is automatically accomplished by selection unit 6 on the basis of the knowledge stored in allocation lists 21, 22, 31, 32, 41, 42, 51, 52, and linked table 10.

In addition, the present invention makes it possible to recognize gaps in the content of database 4, because at all times it is known which information is expected as “relevant” and which of these relevant items of information are actually present.

It can be determined generically, i.e. without knowing in detail the actually available information, which types of information are missing in the currently present information store. These “gaps” can be displayed to the user. By opening, or selecting, these “gaps,” the user can also communicate the current need for additional information to the producer of the information system.

1-10. (canceled)

11. An information system, comprising:
a first database having first data sets, at least one of the first data sets including at least one entry, and at least one element marker being assigned to at least one entry;
a marking unit to mark, as an element, entries in the first data sets by setting at least one element marker assigned to the respective entry;
an element memory for the storage of entries marked as an element; and
an evaluation and linkage unit to evaluate the first database and to store, as element entries in the element memory, entries that have been marked as an element by an element marker that has been set, and for each element entry stored in the element memory, to set up in a link memory at least one linkage with those first data sets in which the respective entry has been marked as an element by an element marker that has been set.

12. The information system of claim 11, further comprising:
an assignment unit to assign second data sets, stored in a second database, to the entries marked as an element in the first data sets by an element marker that has been set;
wherein the evaluation and linkage unit is configured to set up, in the linkage memories of the element entries, additional links with the second data in the second database that are assigned to the same element as the element entries in the link memory.

13. The information system of claim 11, wherein the linkage memories have priority markers and the information system additionally includes a prioritization unit to mark as having primary relevance, by setting the associated priority marker to a first value, links of at least one element entry in the element memory with at least one first data set from the group of the first data sets, and to mark as having secondary relevance, by setting the associated priority marker to a second value differing from the first value, links of at least one element entry in the element memory with at least one second data set from the group of the first data sets.

14. The information system of claim 12, further comprising:
a first database creation unit to create the first data sets in the first database; and
a second database creation unit to create the second data sets in the second database;
wherein the second database creation unit includes a comparator unit to determine, through comparison of, in each case, two second data, a similarity value that is a measure of the similarity of the two second data sets, and to link to one another two second data sets whose similarity value exceeds a specified threshold value.

15. The information system of claim 11, wherein the second data sets include in particular circuit diagrams, test procedures, installation positions, and/or operating instructions, in particular for motor vehicles.

16. A method, the method comprising:
marking at least one entry in first data sets as an element by setting an assigned element marker, wherein a first database includes the first data sets, at least one of the first data sets containing at least one entry, and at least one of the entries being markable as an element by setting an element marker assigned to the entry so as to provide the assigned element marker;
evaluating the first data sets;
storing, as element entries in an element memory, the entries marked as an element by an element marker that has been set; and
setting up, for the element entries stored in the element memory, in a link memory, links with those first data sets in which the entry is marked as an element by an element marker that has been set.

17. The method of claim 16, further comprising:
assigning second data sets, stored in a second database, to the entries marked as an element in the first data sets; and
additionally linking the element entries in the element memory with the second data sets that are assigned to the same element.

18. The method of claim 17, further comprising:
determining, through comparison of, in each case, two second data sets, a similarity value that is a measure of the similarity of the two second data sets, and linkage with one another of the two second data sets if the similarity value exceeds a specified threshold value.

19. The method of claim 17, further comprising:
setting up, for at least one new element, an additional second data set in the second database;
determining, for each second data set already present in the second database, a similarity value that is a measure of the similarity of the additional second data set to the respective already-present second data, and
linking the additional second data set to the already-present second data set if the similarity value exceeds a specified threshold value.

20. The method of claim 16, further comprising:
marking links of the element entries in the element memory having at least one first data set from the group of the first data as having primary relevance, by setting an associated priority marker to a first value; and
marking links of the element entries in the element memory having at least one second data set from the group of the first data sets as having secondary relevance, by setting the associated priority marker to a second value.

21. The method of claim 16, wherein the method is for a motor vehicle workshop.

22. The method of claim 16, wherein each of the first data sets includes at least one entry, and at least one element marker is assigned to each entry.

23. The information system of claim 11, wherein the information system is for a motor vehicle workshop.

24. The information system of claim 11, wherein each of the first data sets includes at least one entry, and at least one element marker is assigned to each entry, and wherein the entries that have been marked as the element by the element marker that has been set, and for each element entry stored in the element memory, to set up in the link memory at least one linkage with those first data sets in which the respective entry has been marked as the element by the element marker that has been set.
